(19) United States
(12) Patent Application Publication
(10) Pub. No.: US 2025/0216229 A1
(43) Pub. Date: Jul. 3, 2025

(54) Electronic Device

(71) Applicant: InnovationLab GmbH, Heidelberg (DE)

(72) Inventor: Jean-nicolas Tisserant, Heidelberg (DE)

(21) Appl. No.: 18/850,263

(22) PCT Filed: Mar. 16, 2023
(86) PCT No.: PCT/EP2023/056831

§ 371 Date: Sep. 24, 2024

(30) Foreign Application Priority Data
Mar. 24, 2022 (LU) LU501704

(51) Int. Cl. G01D 11/30

(52) U.S. Cl. CPC G01D 11/30

(57) ABSTRACT

An electronic device with a plurality of circuit arrangements disposed on a surface of a substrate. The circuit arrangements have a length in a first direction and comprise a first conductive path and a second conductive path. The second conductive path intersects with the first conductive path. The plurality of circuit arrangements further have a plurality of third conductive paths, extending from a first side of the plurality of circuit arrangements to a second side of the plurality of circuit arrangements. The first side is disposed opposite to the second side in the first direction. A first circuit arrangement is offset with respect to a second circuit arrangement of the plurality of circuit arrangement by the length in the first direction. At least one of the third conductive paths of the first circuit arrangement is further connected conductively to the first conductive path of the second circuit arrangement.

### CROSS-REFERENCE TO RELATED APPLICATIONS

This application claims benefit of and priority to LU Patent Application No. LU501704 filed on 24 Mar. 2022.

### FIELD OF THE INVENTION

The field of the invention relates to an electronic device, a method for manufacturing the electronic device, a system, and a method for assembling the system.

### BACKGROUND OF THE INVENTION

Large scale monitoring of physical variables is useful for applications in sectors such as industrial processing, logistics, healthcare, and construction monitoring. Large scale surfaces, such as floors, walls, and ceilings in buildings, as well as in vehicles, such as truck trailers for logistics, are relevant surfaces for the monitoring of physical variables. Walls can be relevant for monitoring the state of a building and detection of damage to the building structure.

### PRIOR ART

A number of patent applications are known which can be used for the monitoring of surfaces. The prior art discloses sensor solutions for monitoring physical variables on a larger scale that are rigid and therefore complicated to mount and expensive. For example, US patent application US 2013/0154441 A1 describes a flooring system with rigid floor tiles for traffic monitoring.

The prior art further describes sensor mats for monitoring physical variables on a larger scale based on capacitive or pressure mapping technologies. For example, U.S. Pat. No. 10,345,984 B2 describes a sensor which reconstructs a continuous position of force on a surface from interpolation based on data signals received from a grid of wires.

Such sensor systems are advantageous in terms of cost and flexibility of design, as the sensor systems are typically printed on flexible substrates using conductive inks. A large number of separate units of these sensor mats need to be installed and wired separately if coverage is required over a large surface.

U.S. Pat. No. 10,451,493B2 describes a system and a process for manufacturing a system including a network of sensors for measuring shear stresses in three dimensions. The network comprises cells and each cell of the network includes a first capacitive sensor for sensing normal pressure in a first direction, a second capacitive sensor for sensing shear stress in a second direction and a third capacitive sensor for sensing shear stress in a third direction. Each of the first capacitive sensor, the second capacitive sensor, and the third capacitive sensor comprises two electrodes. The two electrodes of each of the first capacitive sensor, the second capacitive sensor, and the third capacitive sensor are separated by a dielectric material and are therefore disposed in different levels.

Each of the first capacitive sensor, the second capacitive sensor, and the third capacitive sensor comprise three electrodes on one side of the dielectric material and three electrodes on the other side of the dielectric material. The three electrodes on the one side of the dielectric material of each of the first capacitive sensor, the second capacitive sensor, and the third capacitive sensor are not connected to each other and are therefore separated electrodes. The three electrodes on the other side of the dielectric material of each of the first capacitive sensor, the second capacitive sensor, and the third capacitive sensor are connected to each other using conductive tracks (paths) and thereby form a common electrode structure. The common electrode structure of a single cell is connected to the corresponding common electrode structures of the other cells of the network using the conductive tracks.

The three separated electrodes of a single cell are each connected to corresponding ones of the three separated electrodes of the other cells of the network using the conductive tracks. In other words, the different types of the electrodes (the three separated electrodes and the common electrode structure) of the cells of the network are each only connected to the corresponding same types of electrodes of an adjacent cell in the network but are not connected to other types of the electrodes.

The prior art does not disclose cost-efficient sensor solutions that can be upscaled to arbitrary size and geometries to be used in large scale such as the floor of a warehouse.

### SUMMARY OF THE INVENTION

This document discloses an electronic device for use in a sensor system that can be applied to surfaces of arbitrary size and geometry while reducing the wiring to connect the sensors to a readout device or a processor. A method for manufacturing the electronic device, a system using the electronic device and a method for assembling the system are further described.

According to a first aspect of the invention, the electronic device comprises a substrate and at least a plurality of circuit arrangements, disposed on a facial surface of the substrate. The plurality of circuit arrangements have a length in a first direction and comprise at least one first conductive path, at least one second conductive path, intersecting with the at least one first conductive path, and a plurality of third conductive paths. The plurality of third conductive paths extend from a first side of the plurality of circuit arrangements to a second side of the plurality of circuit arrangements. The first side is disposed opposite to the second side in the first direction. The first conductive paths, the second conductive paths and the third conductive paths in the circuit arrangement are disposed on one facial surface of the substrate.

A first circuit arrangement of the plurality of circuit arrangements is offset with respect to a second circuit arrangement of the plurality of circuit arrangement by the length in the first direction.

At least one of the plurality of third conductive paths of the first circuit arrangement is connected conductively to the at least one first conductive path of the second circuit arrangement. At least one of the plurality of third conductive paths of the first circuit arrangement is further connected conductively to the at least one second conductive path of the second circuit arrangement. Ones of the plurality of third conductive paths of the first circuit arrangement are further connected conductively to ones of the third conductive paths of the second circuit arrangement.

The electronic device can cover large areas that can be equipped with a large number of electronic components, and which enable the addressing of the electronic components from one side of the first circuit arrangement only. The electronic device can be manufactured in a cost-efficient roll-to-roll process.

According to another aspect of the invention, the structure of the first circuit arrangement is identical to the structure of the second circuit arrangement.

The at least one first conductive paths, the at least one second conductive paths and the plurality of third conductive paths can terminate within a connecting area and the third conductive paths can further be arranged parallel to each other.

Sections of the at least one first conductive paths and sections of the at least one second conductive paths can further be arranged parallel to the plurality of third conductive paths and a path direction of the plurality of third conductive paths can be tilted with respect to the first direction.

The plurality of third conductive paths, the sections of the at least one first conductive paths, and the sections of the at least one second conductive paths that are arranged parallel to the third conductive paths can further be equidistantly spaced to each other by a first distance in a second direction. The second direction can be perpendicular to the first direction.

According to another aspect of the invention, an angle between the path direction of the third conductive paths and the first direction can be chosen such that the terminations of the third conductive paths at the second side are offset with respect to the terminations of the third conductive paths at the first side in the second direction at an offset distance with a value that is an integer multiple of a value of the first distance.

One of the first conductive paths can further intersect with more than one of the second conductive paths and/or one of the second conductive paths can intersect with more than one of the first conductive paths.

A method of manufacturing an electronic device is further described. The method comprises the steps of providing a substrate and creating a first circuit arrangement of a plurality of circuit arrangements on a surface of the substrate. The plurality of circuit arrangements have a length in a first direction and comprise at least one first conductive path, at least one second conductive path, intersecting with the at least one first conductive path, and a plurality of third conductive paths. The plurality of third conductive paths extend from a first side of the plurality of circuit arrangements to a second side of the plurality of circuit arrangements. The first side is opposite to the second side in the first direction.

The method further comprises the step of creating a second circuit arrangement of the plurality of circuit arrangements on the surface of the substrate, such that the second circuit arrangement is offset with respect to the first circuit arrangement by the length in the first direction. At least one of the plurality of third conductive paths of the first circuit arrangement is further connected conductively to the at least one first conductive path of the second circuit arrangement. At least one of the plurality of third conductive paths of the first circuit arrangement is further connected conductively to the at least one second conductive path of the second circuit arrangement and ones of the plurality of third conductive paths of the first circuit arrangement are connected conductively to ones of the third conductive paths of the second circuit arrangement.

The first circuit arrangement and the second circuit arrangement can be printed on the surface of the substrate and can further be printed on the surface of the substrate using a roll-to-roll process.

The length can be equal to a circumference of a printing cylinder used in the roll-to-roll process for creating the first circuit arrangement and creating the second circuit arrangement.

A system comprising the electronic device is also described. At least one first electronic component is disposed on the substrate, wherein the at least one first electronic component is connected conductively to the at least one first conductive path of the first circuit arrangement and to the at least one second conductive path of the first circuit arrangement. At least one second electronic component is further disposed on the substrate, wherein the at least one second electronic component is connected conductively to the at least one first conductive path of the second circuit arrangement and to the at least one second conductive path of the second circuit arrangement.

The system can further comprise a connector arranged in the connecting area of the first circuit arrangement. A connecting device can be removably connected to the connector, such that the first conductive path, the second conductive path and the plurality of third conductive paths of the first circuit arrangement are connected conductively to the connecting device.

The first electronic component and the second electronic component can be sensors such as pressure sensors, temperature sensors, damage sensors, or humidity sensors, or other electronic components such as heating elements

A method for assembling the system is further described. The method comprises the steps of providing an electronic device, connecting a first electric component to the at least one first conductive path of the first circuit arrangement and to the at least one second conductive path of the first circuit arrangement. The method further comprises the steps of connecting a second electric component to the at least one first conductive path of the second circuit arrangement and to the at least one second conductive path of the second circuit arrangement and connecting a connector to the at least one first conductive path, the at least one second conductive path and the plurality of third conductive paths of the first circuit arrangement.

### DESCRIPTION OF THE FIGURES

FIG. 1 shows a view of a first aspect of an electronic device.

FIG. 2 shows a view of a first aspect of a system.

FIG. 3 shows a flow chart describing a method for manufacturing the electronic device.

FIG. 4 shows a flow chart describing a method for assembling the system.

### DETAILED DESCRIPTION OF THE INVENTION

The invention will now be described on the basis of the figures. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

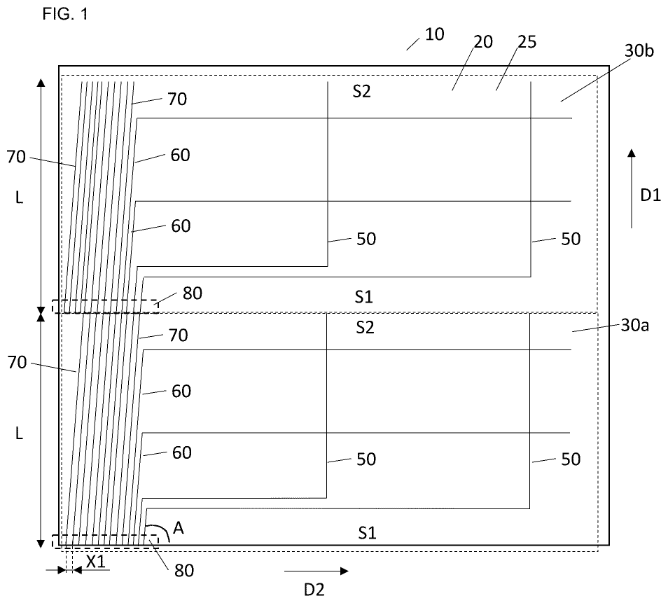

FIG. 1 shows a view of a first aspect of an electronic device 10. A substrate 20 forms the base for the electronic device 10. The substrate 20 has a plate-shaped form with a spread in two spatial dimensions (i.e., in a first direction D1 and a second direction D2 in a plane). This spread is substantially larger than in the third spatial dimension, for example in a normal to the plane. The substrate 20 therefore has two facial surfaces which are significantly greater in size than the remaining four side surfaces of the sides of the substrate 20. The upper one of the facial surfaces is denoted by the reference number 25. It will be appreciated that the term “upper” is only used in this context to distinguish one of the facial surfaces from the other one of the facial surfaces and is not intended to imply a geometrical orientation. The substrate 20 can alternatively have different forms and the rectangular form shown in FIG. 1 is not limiting of the invention.

The substrate 20 can be made from a non-conductive material such as a polymer. The substrate 20 may, for example, be made from a polymer such as poly(ethyleneterephthalate) (PET), poly(ethylenenaphthalate) (PEN), polyimide (PI), thermoplastic polyurethane (TPU), poly(dimethylsiloxane) (PDMS). Further suitable examples for substrate materials are paper and cardboard. Glass, silicone based substrates, woven fabrics, nonwoven fabrics, nonwoven mats, fiber mats and plies, in particular glass fiber mats and plies may alternatively be used as a material for the substrate 20. Suitable fiber mats and plies include in particular fiber mats and plies which are used for producing fiber reinforced composite materials. Suitable fabrics include, for example, cotton or polymer based woven and nonwoven fabrics. The thickness of the substrate can be in the range of from 5 μm to 500 μm, preferably in the range of from 50 μm to 200 μm. The substrate 20 can comprise a single layer only or multiple layers made of different materials in the form of a substrate laminate. In one aspect of the invention, the substrate 20 is a flexible foil made of polymer or metal, which can be used in a printing process, such as but not limited to a roll-to-roll process. The substrate 20 can be coated with a dielectric layer, in case the substrate 20 is made of metal. The substrate 20 has typically a thickness of between 50 μm and 200 μm, but this is not limiting of the invention.

A first circuit arrangement 30a and a second circuit arrangement 30b are disposed on the upper facial surface 25 of the substrate 20. The circuit arrangements 30a, 30b have a length L in the first direction D1, a first side S1 and a second side S2. The second side S2 is disposed opposite to the first side S1 in the direction D1.

The first circuit arrangement 30a is offset to the second circuit arrangement 30b in the first direction D1 by the length L. The first circuit arrangement 30a and the second circuit arrangement 30b are thus arranged adjacent to each other with respect to the first direction D1. The second side S2 of the first circuit arrangement 30a is therefore in contact with the first side S1 of the second circuit arrangement 30b. The first circuit arrangement 30a and the second circuit arrangement 30b are further not offset to each other in the second direction D2.

The circuit arrangements 30a, 30b comprise two first conductive paths 50, two second conductive paths 60 and a plurality of third conductive paths 70. The first conductive paths 50, the second conductive paths 60 and the third conductive paths 70 are printed on the upper facial surface 25 of the substrate 20 and can be made of silver-containing material or other kinds of material with a comparable high electrical conductivity of at least 10⁵ S/m. Examples of further kinds of materials include, but are not limited to, copper or gold as well as alloys thereof and carbon-containing composite materials. Using a material with high electrical conductivity allows electrical current to flow through the first conductive paths 50, the second conductive paths 60 and the third conductive paths 70. The first conductive paths 50, the second conductive paths 60 and the third conductive paths 70 can alternatively be applied to the substrate 20 by any other manufacturing process such as but not limited to stitching or bonding or photolithography.

The third conductive paths 70 are designed as straight lines, are arranged parallel to each other, and extend from the first side S1 to the second side S2 of the circuit arrangements 30a, 30b. The third conductive paths 70 are further equidistantly spaced to each other by a first distance X1 in the second direction D2 and are tilted with respect to the first direction D1, defining an angle A between a path direction of the third conductive paths 70 and the first direction D1. The third conductive paths 70 can alternatively have a different form, orientation, and arrangement with respect to each other.

The first conductive paths 50 comprise three sections of different orientation. The first conductive paths 50 are designed as straight lines within each of the three sections of different orientation. A first section starting from the first side S1 is arranged parallel to the third conductive paths 70. A second section is arranged substantially parallel to the second direction D2 and a third section is arranged substantially parallel to the first direction D1. The first conductive paths 50 can alternatively have a different form, orientation, and arrangement with respect to each other.

The second conductive paths 60 comprise two sections of different orientation. The second conductive paths 60 are designed as straight lines within each of the two sections of different orientation. A first section starting from the first side S1 is arranged parallel to the third conductive paths 70 and a second section is arranged substantially parallel to the second direction D2. The second conductive paths 60 can alternatively have a different form, orientation, and arrangement with respect to each other.

The first sections of the first conductive paths 50, the first sections of the second conductive paths 60 and the third conductive paths 70 are equidistantly spaced to each other by the first distance X1 in the second direction D2.

The first conductive paths 50, the second conductive paths 60 and the third conductive paths 70 are arranged in a specific order in the first direction D1. The second conductive paths 60 are arranged between the third conductive paths 70 and the first conductive paths 50. This order can alternatively be varied.

The first conductive paths 50 and the second conductive paths 60 intersect each other, such that the second section of the second conductive paths 60 intersects with the third section of the first conductive paths 50. The first conductive paths 50 and the second conductive paths 60 thus form a grid or 2×2 matrix but can alternatively form any other kind of pattern. The first conductive paths 50 and the second conductive paths 60 can e.g., form a m×n matrix if the circuit arrangements 30a, 30b comprise m of the first conductive paths 50 and n of the second conductive paths 60.

The first conductive paths 50 and the second conductive paths 60 can be coated with a dielectric at their intersection to avoid electrical contact between the first conductive paths 50 and the second conductive paths 60 at the intersection. The first conductive paths 50 and the second conductive paths 60 can alternatively have an interruption around the intersection to avoid electrical contact between the first conductive paths 50 and the second conductive paths 60 at the intersection.

The first circuit arrangement 30a and the second circuit arrangement 30b have an identical structure, in other words there are an identical number, form and arrangement of the first conductive paths 50, the second conductive paths 60 and the third conductive paths 70.

Electronic components 130, 140 can be arranged near the intersections and can be connected conductively to the first conductive paths 50 and the second conductive paths 60. Four electronic components 130, 140 can therefore be arranged at the first circuit arrangement 30a and can be individually addressed using a pair of one of the first conductive paths 50 and one of the second conductive paths 60 of the first circuit arrangement 30a. The same applies to the second circuit arrangement 30b.

The third conductive paths 70, the first section of the first conductive paths 50 and the first section of the second conductive paths 60 terminate at the first side S1 within a connecting area 80.

The terminations of the third conductive paths 70 at the second side S2 are offset with respect to the terminations of the third conductive paths 70 at the first side S1, as the third conductive paths 70 are tilted with respect to the first direction D1. The circuit is designed that terminations of ones of the third conductive paths 70 of the first circuit arrangement 30a at the second side S2 are in contact conductively with terminations of the number of the first conductive paths 50, the number of the second conductive paths 60 and ones of the third conductive paths 70 of the second circuit arrangement 30b at the first side S1. This conductive contact is enabled by choosing the relevant parameters (such as the angle A, the first distance X1, the number of the first conductive paths 50, the second conductive paths 60 and the third conductive paths 70 and the length L) in such a manner that overlaps occur between the first conductive paths 50, the second conductive paths 60 and the third conductive paths 70.

The terminations of the third conductive paths 70 at the second side S2 are offset to the terminations of the third conductive paths 70 at the first side S1 in the second direction D2 at an offset distance with a value that is four times the first distance X1. Two of the third conductive paths 70 of the first circuit arrangement 30a therefore contact the two first conductive paths 50 of the second circuit arrangement 30b. Two of the third conductive paths 70 of the first circuit arrangement 30a further contact the two second conductive paths 60 of the second circuit arrangement 30b. Further ones of the third conductive paths 70 of the first circuit arrangement 30a contact further ones of the third conductive paths 70 of the second circuit arrangement 30b. The angle A can alternatively be varied depending on the value of the first distance X1, the number of the first conductive paths 50, the second conductive paths 60 and the third conductive paths 70 and the length L. L is preferably taken to be the circumference of a printing roll, if roll-to-roll printing is used.

The first conductive paths 50, the second conductive paths 60 and ones of the third conductive paths 70 of the second circuit arrangement 30b are therefore connected conductively to ones of the third conductive paths 70 of the first circuit arrangement 30a and can therefore be contacted by contacting the terminations of the ones of the third conductive paths 70 of the first circuit arrangement 30a at the first side S1. It is therefore possible to address the electronic components 130, 140 arranged on the substrate 20 and connected to ones of the first conductive paths 50 and ones of the second conductive paths 60 of the second circuit arrangement 30b by contacting the ones of the third conductive paths 70 of the first circuit arrangement 30a in the contacting area 80 of the first circuit arrangement 30a.

The electronic device 10 thus allows to address the electronic components 130, 140 that are connected to the conductive paths 50, 60 of one of the circuit arrangements 30a, 30b by contacting the ones of the conductive paths 50, 60, 70 of the first circuit arrangement 30a in the contacting area 80 of the first circuit arrangement 30a.

More than two circuit arrangements can alternatively be disposed on the substrate 20, which allows to increase the number of the intersections of the conductive paths 50, 60 that can be addressed by contacting the conductive paths 50, 60, 70 in the connecting area 80 of the first circuit arrangement 30a. The number of circuit arrangements disposed on the substrate 20 is basically restricted by the size of the substrate 20, the size of the circuit arrangements and the number of the conductive paths 50, 60, 70.

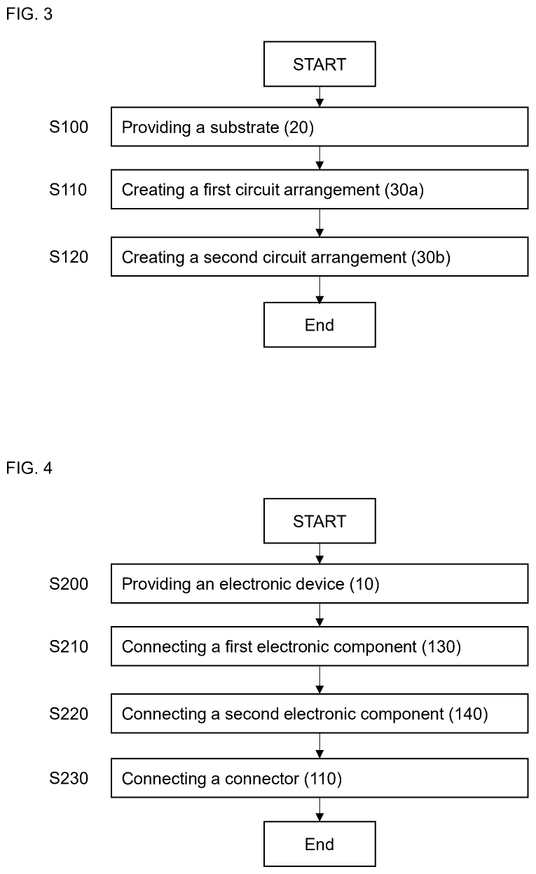

The electronic device 10 can therefore cover large areas that can be equipped with a large number of the electronic components 130, 140 and that allow to address all the electronic components 130, 140 from the contacting area 80 of the first circuit arrangement 30a. The electronic device 10 enables manufacturing of such large matrices in a cost-efficient roll-to-roll process, as described in detail for FIG. 3.

The electronic device 10 can have a form that differs from a rectangular form. The electronic device 10 can even be cut, twisted, or folded into an arbitrary 2D and 3D forms or shapes without losing the described functionality.

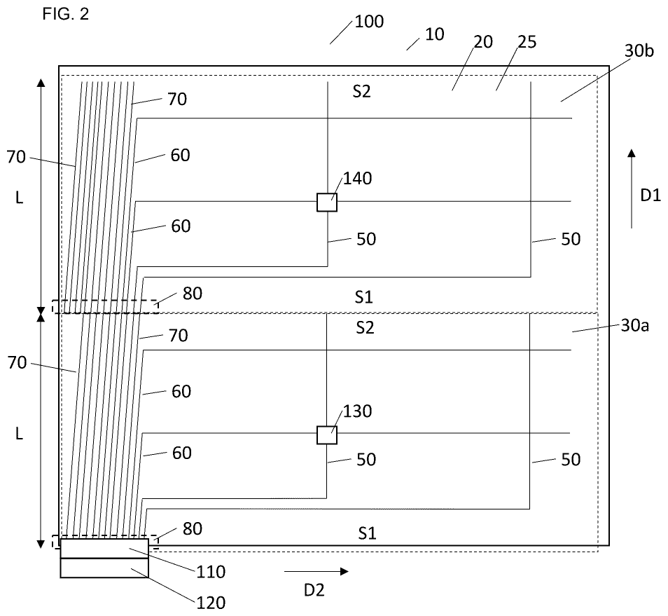

FIG. 2 shows a view of a first aspect of a system 100. Similar features shown in FIG. 2 as those in FIG. 1 are not described in detail again and the same reference signs are used. An electronic device 10 has a first circuit arrangement 30a and a second circuit arrangement 30b, arranged on the upper facial surface 25 of the substrate 20. A first electronic component 130 and a second electronic component 140 are disposed on the substrate 20 near intersections of first conductive paths 50 and second conductive paths 60 of the circuit arrangements 30a, 30b.

A connector 110 is disposed at the substrate 20 in a connecting area 80 of the first circuit arrangement 30a. The connector 110 is connected conductively to the conductive paths 50, 60, 70 of the first circuit arrangement 30a and allows to connect removably a connecting device 120 to the connector 110. The connecting device 120 is connected conductively to the first conductive paths 50, the second conductive paths 60 and the third conductive paths 70 of the first circuit arrangement 30a if connected to the connector 110. The connector 110 can be a plug connector.

The first electronic component 130 is connected conductively to one of the first conductive paths 50 and one of the second conductive paths 60 of the first circuit arrangement 30a, e.g., by soldering. The first electronic component 130 can therefore be addressed using this pair of the conductive paths 50, 60, e.g., by contacting this pair of the conductive paths 50, 60 via the connector 110.

The second electronic component 140 is connected conductively to one of the first conductive paths 50 and one of the second conductive paths 60 of the second circuit arrangement 30b, e.g., by soldering. The second electronic component 140 can therefore be addressed using a pair of the third conductive paths 70 of the first circuit arrangement 30a which are connected conductively to the pair of the conductive paths 50, 60 of the second circuit arrangement 30b which is connected conductively to the second electronic component 140, e.g., by contacting the pair of the third conductive paths 70 of the first circuit arrangement 30a via the connector 110.

The electronic device 10 can alternatively comprise plug connectors which are arranged near the intersections of the conductive paths 50, 60. The plug connectors can be connected conductively to the conductive paths 50, 60 and allow to plug in the electronic components 130, 140 to connect the electronic components 130, 140 conductively to the conductive paths 50, 60.

The electronic components 130, 140 can be attached to the substrate 20 e.g., by gluing or using mechanical fasteners such as screws, clamps or bolts or can only be held in place by their connection to the conductive paths 50, 60.

The system 100 can alternatively comprise a larger number of electronic components arranged near a larger number of intersections of the conductive paths 50, 60.

The electronic components 130, 140 can be components such as pressure sensors humidity sensors, damage sensors or temperature sensors. The system 100 is a sensor system or sensor mat in this case with sensors arranged in a matrix. These kind of sensor systems can be used to measure parameters over a large area in e.g., walls, ceilings or floors of buildings or vehicles such as truck trailers. These sensor systems can be designed and manufactured with large dimensions wherein the sensors can be addressed with a reduced number of the connectors 110 that are only needed at one side of the electronic device 10 of the system 100. This reduces the amount of wiring needed for addressing all of the electronic components 130, 140.

The electronic components 130, 140 can alternatively be components such as light-emitting diodes, heating elements, any kind of actors or sensors or any other kind of electronic components.

The connecting device 120 can be capable of receiving signals from the electronic components 130, 140 for e.g., receiving sensor measurements as well as to output signals to the electronic components 130, 140 for e.g., controlling an actor. The connecting device 120 can comprise a processor and/or a data transmission device.

FIG. 3 shows a flow chart describing a method for manufacturing the electronic device 10. A substrate 20 is provided in step S100 and a plurality of circuit arrangements 30a, 30b are further created. A first circuit arrangement 30a of the plurality of circuit arrangements 30a, 30b is created on the upper facial surface 25 of the substrate 20 in step S110 and a second circuit arrangement 30b of the plurality of circuit arrangements is created on the upper facial surface 25 of the substrate 20 in step S120.

The circuit arrangements 30a, 30b have a length L in a first direction D1 and comprise at least one first conductive path 50, at least one second conductive path 60 and a plurality of third conductive paths 70. The at least one second conductive path 60 intersects the at least one first conductive path 50. The third conductive paths 70 extend from a first side S1 to a second side S2 of the circuit arrangements 30a, 30b. The first side S1 is disposed opposite to the second side S2 in the first direction D1.

The first conductive paths 50, the second conductive paths 60 and the third conductive paths 70 are disposed on the upper facial surface 25 of the substrate 20. As noted above, first conductive paths 50, the second conductive paths 60 and the third conductive paths 70 can be made of silver-containing material or other kinds of material with a comparable high electrical conductivity of at least 10⁵ S/m.

In another aspect of the invention the first conductive paths 50, the second conductive paths 60 and the third conductive paths 70 can be printed onto the substrate 20 in a roll-to-roll process. The substrate 20 is moved in the first direction D1 during the roll-to-roll process. The substrate 20 and therefore the electronic device 10 can have a maximum width in the second direction D2 that is equal to the width of the printing cylinder used in the roll-to-roll process. The length L equates to the circumference of the used printing cylinders. Using a roll-to-roll process allows to manufacture the electronic device 10 with reduced costs and with reduced manufacturing time.

The design of the electronic device 10 allows to print multiple circuit arrangements 30a, 30b one after another in the first direction D1 onto the substrate. The electric components 130, 140 which are arranged on the substrate 20 and which are connected to conductive paths 50, 60 of the circuit arrangements 30a, 30b can be addressed by using one connector 110 only which is arranged at one side of the electronic device 10. It is therefore possible to manufacture large electronic devices 10 at reduced costs and with reduced wiring.

The conductive paths 50, 60, 70 can alternatively be applied to the substrate 20 by any other manufacturing process such as but not limited to stitching or bonding.

FIG. 4 shows a flow chart describing a method for assembling the system 100. An electronic device 10 is provided in step S200. A first electronic component 130 is connected conductively to a first conductive path 50 and a second conductive path 60 of a first circuit arrangement 30a in step S210. A second electronic component 140 is connected conductively to a first conductive path 50 and a second conductive path 60 of a second circuit arrangement 30b in step S220.

The electronic components 130, 140 can be connected conductively to the conductive paths 50, 60 by soldering contacts of the electronic components 130, 140 to the conductive paths 50, 60 or by using any other method of connecting conductively electronic components to conductive paths or cables.

A connector 110 is further connected conductively to the first conductive path 50, the second conductive path 60 and a plurality of conductive paths 70 of the first circuit arrangement 30a. The connector can be connected conductively to the conductive paths 50, 60, 70 by soldering contacts of the connector 110 to the conductive paths 50, 60, 70 or by using any other method of connecting conductively connectors to conductive paths or cables.

### REFERENCE NUMERALS

10 electronic device
20 substrate
25 upper facial surface
30a first circuit arrangement
30b second circuit arrangement
50 first conductive path
60 second conductive path
70 third conductive path
80 connecting area
100 system
110 connector
120 connecting device
130 first electronic component
140 second electronic component
A angle
D1 first direction
D2 second direction
L length
S1 first side
S2 second side
X1 first distance
S100 providing a substrate
S110 creating a first circuit arrangement
S120 creating a second circuit arrangement
S200 providing an electronic device
S210 connecting a first electronic component
S220 connecting a second electronic component
S230 connecting a connector

1. An electronic device, comprising:
a substrate; and
at least a plurality of circuit arrangements, disposed on a surface of the substrate, the plurality of circuit arrangements having a length in a first direction and comprising at least one first conductive path, at least one second conductive path, intersecting with the at least one first conductive path, and a plurality of third conductive paths, the plurality of third conductive paths extending from a first side of the plurality of circuit arrangements to a second side of the plurality of circuit arrangements, wherein the first side is disposed opposite to the second side in the first direction;
wherein
a first circuit arrangement of the plurality of circuit arrangements is offset with respect to a second circuit arrangement of the plurality of circuit arrangement by the length in the first direction;
at least one of the plurality of third conductive paths of the first circuit arrangement is connected conductively to the at least one first conductive path of the second circuit arrangement;
at least one of the plurality of third conductive paths of the first circuit arrangement is connected conductively to the at least one second conductive path of the second circuit arrangement; and
ones of the plurality of third conductive paths of the first circuit arrangement are connected conductively to ones of the third conductive paths of the second circuit arrangement;

2. The electronic device according to claim 1, wherein the structure of the first circuit arrangement is identical to the structure of the second circuit arrangement;

3. The electronic device according to claim 1, wherein the at least one first conductive paths, the at least one second conductive paths and the plurality of third conductive paths terminate within a connecting area.

4. The electronic device according to claim 1, wherein the third conductive paths are arranged parallel to each other.

5. The electronic device according to claim 1, wherein sections of the at least one first conductive paths and sections of the at least one second conductive paths are arranged parallel to the plurality of third conductive paths.

6. The electronic device according to claim 1, wherein a path direction of the plurality of third conductive paths is tilted with respect to the first direction.

7. The electronic device according to claim 1, wherein
the plurality of third conductive paths, the sections of the at least one first conductive paths and the sections of the at least one second conductive paths that are arranged parallel to the third conductive paths are equidistantly spaced to each other by a first distance in a second direction; and
the second direction is perpendicular to the first direction.

8. The electronic device according to claim 1, wherein an angle between the path direction of the third conductive paths and the first direction is chosen such that the terminations of the third conductive paths at the second side are offset with respect to the terminations of the third conductive paths at the first side in the second direction at an offset distance with a value that is an integer multiple of a value of the first distance.

9. The electronic device according to claim 1, wherein
one of the first conductive paths can intersect with more than one of the second conductive paths and/or one of the second conductive paths can intersect with more than one of the first conductive paths.

10. A method of manufacturing an electronic device, the method comprising the steps of:
providing a substrate;
creating a first circuit arrangement of a plurality of circuit arrangements on a surface of the substrate, the plurality of circuit arrangements having a length in a first direction and comprising at least one first conductive path, at least one second conductive path, intersecting with the at least one first conductive path, and a plurality of third conductive paths, the plurality of third conductive paths extending from a first side of the plurality of circuit arrangements to a second side of the plurality of circuit arrangements, wherein the first side is opposite to the second side in the first direction; and
creating a second circuit arrangement of the plurality of circuit arrangements on the surface of the substrate ;
such that
the second circuit arrangement is offset with respect to the first circuit arrangement by the length in the first direction;
at least one of the plurality of third conductive paths of the first circuit arrangement is connected conductively to the at least one first conductive path of the second circuit arrangement;
at least one of the plurality of third conductive paths of the first circuit arrangement is connected conductively to the at least one second conductive path of the second circuit arrangement; and
ones of the plurality of third conductive paths of the first circuit arrangement are connected conductively to ones of the third conductive paths of the second circuit arrangement.

11. The method of manufacturing an electronic device according to claim 10, wherein the first circuit arrangement and the second circuit arrangement are printed on the surface of the substrate.

12. The method of manufacturing an electronic device according to claim 10, wherein the first circuit arrangement and the second circuit arrangement are printed on the surface of the substrate using a roll-to-roll process.

13. The method of manufacturing an electronic device according to claim 10, wherein the length is equal to a circumference of a printing cylinder used in the roll-to-roll process for creating the first circuit arrangement and creating the second circuit arrangement.

14. A system comprising:
an electronic device comprising:
a substrate; and
at least a plurality of circuit arrangements, disposed on a surface of the substrate, the plurality of circuit arrangements having a length in a first direction and comprising at least one first conductive path, at least one second conductive path, intersecting with the at least one first conductive path, and a plurality of third conductive paths, the plurality of third conductive paths extending from a first side of the plurality of circuit arrangements to a second side of the plurality of circuit arrangements, wherein the first side is disposed opposite to the second side in the first direction;
wherein
a first circuit arrangement of the plurality of circuit arrangements is offset with respect to a second circuit arrangement of the plurality of circuit arrangement by the length in the first direction;
at least one of the plurality of third conductive paths of the first circuit arrangement is connected conductively to the at least one first conductive path of the second circuit arrangement;
at least one of the plurality of third conductive paths of the first circuit arrangement is connected conductively to the at least one second conductive path of the second circuit arrangement; and
ones of the plurality of third conductive paths of the first circuit arrangement are connected conductively to ones of the third conductive paths of the second circuit arrangement;
at least one first electronic component disposed on the substrate, wherein the at least one first electronic component is connected conductively to the at least one first conductive path of the first circuit arrangement and to the at least one second conductive path of the first circuit arrangement; and
at least one second electronic component disposed on the substrate, wherein the at least one second electronic component is connected conductively to the at least one first conductive path of the second circuit arrangement and to the at least one second conductive path of the second circuit arrangement.

15. The system according to claim 14, further comprising a connector arranged in the connecting area of the first circuit arrangement, wherein a connecting device can be removably connected to the connector, such that the first conductive path, the second conductive path and the plurality of third conductive paths of the first circuit arrangement are connected conductively to the connecting device.

16. The system according to claim 14, wherein the first electronic component and the second electronic component are sensors such as pressure sensors, humidity sensors, damage sensors or temperature sensors.

17. A method for assembling a system, the method comprising the steps of:
providing an electronic device comprising:
a substrate; and
at least a plurality of circuit arrangements, disposed on a surface of the substrate, the plurality of circuit arrangements having a length in a first direction and comprising at least one first conductive path, at least one second conductive path, intersecting with the at least one first conductive path, and a plurality of third conductive paths, the plurality of third conductive paths extending from a first side of the plurality of circuit arrangements to a second side of the plurality of circuit arrangements, wherein the first side is disposed opposite to the second side in the first direction;
wherein
a first circuit arrangement of the plurality of circuit arrangements is offset with respect to a second circuit arrangement of the plurality of circuit arrangement by the length in the first direction;
at least one of the plurality of third conductive paths of the first circuit arrangement is connected conductively to the at least one first conductive path of the second circuit arrangement;
at least one of the plurality of third conductive paths of the first circuit arrangement is connected conductively to the at least one second conductive path of the second circuit arrangement; and
ones of the plurality of third conductive paths of the first circuit arrangement are connected conductively to ones of the third conductive paths of the second circuit arrangement;
connecting a first electric component to the at least one first conductive path of the first circuit arrangement and to the at least one second conductive path of the first circuit arrangement;
connecting a second electric component to the at least one first conductive path of the second circuit arrangement and to the at least one second conductive path of the second circuit arrangement; and
connecting a connector to the at least one first conductive path, the at least one second conductive path and the plurality of third conductive paths of the first circuit arrangement.
